(19) United States
(12) Patent Application Publication
(10) Pub. No.: US 2024/0353341 A1
(43) Pub. Date: Oct. 24, 2024

(54) Method and Device for the Quantitative Measurement of Lead

(71) Applicant: Eric Carl Ritter, hauppauge, NY (US)

(72) Inventor: Eric Carl Ritter, hauppauge, NY (US)

(73) Assignee: Fluoro-Spec Inc., East Setauket, NY (US)

(21) Appl. No.: 18/762,582

(22) Filed: Jul. 2, 2024

(51) Int. Cl. G01N 21/78; G01N 31/02

(52) U.S. Cl. CPC G01N 21/78; G01N 31/02

(57) ABSTRACT

The present invention comprises a method and device for the quantitative determination of levels of lead in paint. The device effectuates the completion of the method which involves selecting a measured sample of paint, vaporizing the paint sample, capturing the vaporized reaction products in a reaction vessel, and dissolving the resultant lead oxide into solution using aqueous acid, adding a titrated amount of a first chemical agent into the vessel capable of precipitating a desired quantity of lead from the solution, creating a color change. If there is an indication that lead is present, as measured by the color change, the operator adds a second chemical to the sample mixture, which reveals levels of lead which exceed the stoichiometric reaction with the first titrated reagent by a second color change. Thereby making a reliable, quantitive determination of lead content.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A LARGE TABLE, OR A COMPUTER PROGRAM LISTING APPENDIX ON READ-ONLY OPTICAL DISC

Not Applicable

### BACKGROUND OF THE INVENTION

### Technical Field

The presence of lead poses significant health risks, particularly to children and pregnant women. Additionally adults suffer ill health effects, including death by way of cardiovascular disease and ischemic heart injury as a result of lead exposure. Lead is the single greatest cause of unexplained intellectual disability in children and is responsible for hundreds of thousands of deaths per year in the United States alone through its effects on the cardiovascular system.

Lead has been used in paint and other consumer products for thousands of years, while its dangers have been known its use continued. In the case of paint regulation was slow and began in 1973 when the Consumer Products Safety Commission made the first effort to regulate the lead content in paint. The Commission established a definition of “lead based paint” to be defined as paint with a lead metal content of 0.06% lead w/w. In 1978, lead based paint was banned in residential structures and in 1988 the government re-defined lead based paint to mean any painted surface with a concentration of lead of 1 milligram per square centimeter or more.

In 1990, the U.S. Department of Housing and Urban Development (“HUD”) published “Lead-Based Paint: Interim Guidelines for the Identification and Abatement of Lead-Based Paint in Public and Indian Housing.” The HUD guidelines described technical protocols, practices and procedures for testing, abatement, and worker protection in cleanup and disposal of lead-based paint.

In 1992 the Residential Lead-Based Hazard Reduction Act, Title X, was passed. Title X established new requirements for homeowners and Federal agencies, and new actions to improve the safety and effectiveness of lead-based paint identification and remediation activities. This act requires the sellers of homes to disclose the potential existence of any lead-based paint or hazard in pre-1978 homes, and allow purchasers 10 days to inspect for lead based paint before becoming obligated to purchase the house. The 1992 Act also redefined lead based paint again, to mean 1 milligram per square centimeter or 5,000 parts per million—to accommodate the possibility of an inconclusive result in the field test.

EPA allows for the determination of the presence or absence of lead based paint to be carried out by a EPA certified professional using an approved portable X-Ray fluorescence spectrometer. Additionally professionals can use chemical test kits, which are much less expensive to determine the absence of lead based paint. The EPA website as of May 5th 2024 reads as follows.

“Lead test kits recognized before Sep. 1, 2010 must meet only the negative response criterion outlined in 40 CFR 745.88 (c)(1). The negative response criterion states that for paint containing lead at or above the regulated level, 1.0 mg/cm² or 0.5% by weight, a demonstrated probability (with 95% confidence) of a negative response less than or equal to 5% of the time must be met. The recognition of kits that meet only this criterion will last until EPA publicizes its recognition of the first test kit that meets both of the criteria outlined in the rule. Lead test kits recognized after Sep. 1, 2010 must meet both the negative response and positive response criteria outlined in 40 CFR 745.88 (c)(1) and (2). The positive-response criterion states that for paint containing lead below the regulated level, 1.0 mg/cm² or 0.5% by weight, a demonstrated probability (with 95% confidence) of a positive response less than or equal to 10% of the time must be met. Despite the EPA's commitment of resources to this effort, to date no lead test kit has met both of the performance criteria outlined in the RRP rule. However, there are three EPA-recognized lead test kits that meet the negative response criterion and continue to be recognized by EPA.”

EPA does allow for a 20% margin of error within the chemical testing protocol. Results of the test ranging from 800 milligrams per square centimeter and 1200 milligrams per square centimeter are not counted towards the confidence readings of either the positive or negative results criteria.

The ability for purchasers to test their prospective homes for lead afforded by Title X had huge potential to reduce the amount of poisonings. While the law gave prospective home buyers the right to test, currently there are no EPA Recognized tests that are approved for use by non technically trained individuals and there are no EPA Recognized test kits that can determine the presence of lead based paint merely its absence. Meaning that consumers are forced to use contractors to test their homes if they want the results to have any legal status.

### DESCRIPTION OF THE PRIOR ART

A FIRST EXAMPLE can be see in U.S. Pat. No. 5,039,618A 989-02-02 1991 Aug. 13 Hybrivet Systems, Inc. “Test swab cartridge type device and method for detecting lead and cadmium”. Uses sodium rhodizonate and an aqueous acid to react with surface lead by forcing the reagent liquid through a filter and rubbing the tip on the testing surface.

A SECOND EXAMPLE can be seen in U.S. Pat. No. 5,558,835A*1994 May 9 1996 Sep. 24 Universal Synergetics, Inc. “Lead test dauber”. Uses sodium rhodizonate impregnated on the tip of a abrasive swab which aids in accessing lead paint within the surface.

A THIRD EXAMPLE of a similar device for determining the contents of paint can be seen in U.S. Pat. No. 6,214,291B1 1998 Sep. 22 2001 Apr. 10 Markegon L.L.C. “Paint test apparatus” this test kit is for latex paint, however it also attempts to abrade the surface to allow for the substrate to mix with the reagent mixture.

A FOURTH EXAMPLE can be seen in D-Lead, Manufactured by ESCA Tech. It comprises a bottle of aqueous sodium hydroxide, into which a paint chip; produced by a core type sampling tool is deposited. The dissolved lead then is reacted with ammonium sulfide to produce a black color. Unlike prior examples this testing product removes a chip of paint from the surface.

A FIFTH EXAMPLE can be seen in, U.S. Pat. No. 5,014,287A*1990 Apr. 18 1991 May 7 Thornton Michael G Portable “x-ray fluorescence spectrometer for environmental monitoring of inorganic pollutants” describes such an instrument, which is capable to determining the amount of lead within an in situ paint sample by means of measuring the x-ray fluorescence of a sample of lead. This technology is validated by EPA and accepted, for the determination of the presence or absence of regulated lead. This test is non-destructive and happens quickly. XRF technology uses X-Rays that penetrate multiple layers of paint and can detect buried lead as well as surface lead.

A SIXTH EXAMPLE can be seen in U.S. Pat. No. 6,800,485B2 “Chemical spot test for lead in paint and other media” wherein a color chart is proposed to help the operator determine the level of lead present in the sample.

A SEVENTH EXAMPLE can be seen in The State of Massachusetts Test, which relies on sodium sulfide testing in situ paint. Sodium sulfide is applied to paint and a change to a black color is noted.

AN EIGHTH EXAMPLE can be seen in EP2022058881W⋅2022 Apr. 4 STICHTING NEDERLANDSE WETENSCHAPPELIJK ONDERZOEK INST “METHOD FOR DETECTING LEAD” wherein lead is converted to a fluorescent form via addition of a perovskite precursor chemical mixed with isopropanol and the resultant lead configuration is illuminated by ultraviolet light to disclose the presence of lead on the surface of a substrate.

### Technical Problem

Currently only EPA trained professionals or a certified renovator may operate a chemical test kit to determine the absence of lead based paint. Even if a professional operator attempted to use a chemical test kit to screen a home for the presence of lead based paint at the request of a prospective buyer there could not be a conclusion of the presence of lead based paint drawn. Only a determination of its absence by a negative test result. This problem is really only a symptom, because currently there are no chemical test kits which can accurately delineate between regulated and unregulated levels of lead in paint.

All of the aforementioned EPA recognized test kits fail the EPA requirement for a chemical test kit evaluated after 2010. While they meet the first criteria of a positive result with 95% accuracy on lead based paint over 1 milligrams per square centimeter. They fail to test negative result criteria adequately, In fact when evaluated they often tested positive when there was no lead at all present. The requirement of chemical test kits for paint which test negative at a concentration less than 1 milligram 90% of the time has yet to be met by a chemical test kit and as such there is a ongoing need for a portable, low cost and accurate chemical testing method to determine both the presence and absence of lead based paint in accordance with EPA requirements, optimally one which can be used by professionals and non professionals alike. Additionally there is a requirement that these testing kits can accurately discern the presence or absence of regulated lead in both lead carbonate (white lead) and lead chromate (yellow lead) containing paint samples. Chemical tests also struggle in this regard, lead carbonate is relatively easy to break down with chemicals while lead chromate is much more difficult to break down. Leading to a situation where field digestion methods cannot be accurately used to test a paint sample. Since all the aforementioned test kits rely on chemical digestion of paint samples they fail to detect lead chromate often.

There are several other reasons the testing methods and kits used today are insufficient. First, all fail to completely homogenize the sample, LeadCheck and State of Massachusetts tests both merely test the surface, while D-Lead takes a paint chip and tests the whole chip. Even when the operator breaks down the sample mechanically with a tool the chemical compounds of lead are still intact. The D-Lead field digestion liquid is an aqueous sodium hydroxide solution and does not break down lead chromate effectively and while methods of complete sample digestion exist such as high temperature acid digestion, microwave assisted digestion which is often aided by grinding or milling the sample. None are sufficient for field use since they take a long time and require too much operator involvement and require large equipment with high power requirements. Additionally, all of the state of the art testing methods rely on reaction strategies where there is an excess of the reagent, sulfide or rhodizonate, to effectuate the color change. This means thats there is no way to modulate the reaction parameters so the operator can judge the total amount of of the lead in the sample. Third the testing methods cannot achieve reliable results for both types of lead paint since they rely strictly on a chemical method of extracting the lead from both chromate and carbonate lead containing paint. As mentioned these two lead compounds are chemically very different, lead chromate has a strong ionic bond between the lead and the chromium while the lead in lead carbonate is weakly bound. Finally all these chemical methods, since they do not react the totality of the lead in the sample, and cannot do anything more than approximate the level of lead by testing for lead exposed on a surface are insufficient to determine levels of regulated lead accurately. In circumstances where regulated lead exists as a function of multiple layers of unregulated lead paint covering lead paint, none of these test chemical test methods are remotely sufficient, unlike XRF which can adequately determine if the sample is regulated or not by penetrating all layers with X-Rays. Current chemical tests rely on a presumption of the presence or absence of lead, and are not quantitative.

Given the limitations of existing technologies, there is a clear need for an improved method for the quantitative chemical detection of lead in paint. These methods and devices are insufficient to protect the publics health because they cannot detect lead reliably and quantitatively, more expensive and involved methods cannot be deployed in a cost effective manor by untrained individuals safely and cannot delineate between regulated and unregulated lead.

### BRIEF SUMMARY OF THE INVENTION

A solution should be accurate across different circumstances of paint, such as chemical composition, exposed vs overpainted, degraded vs un-degraded. Additionally such a solution should be cost-effective, easy to use, and suitable for on-site testing. It should overcome the drawbacks of current field testing methods by providing reliable results without the need for extensive training, expensive and complex equipment or laboratory analysis.

Since a determination of lead-based paint is dependent on the loading concentration over one square centimeter of paint, currently at 1 mg per square centimeter and may comprise white or yellow lead. A solution to the chemical detection of lead-based paint must overcome both the problem of detecting discrete lead compounds and detecting the totality of lead within a sample, even if the sample is overpainted. While giving the operator quantitative results on the amount of lead present. To accomplish this a sample is first selected by a tool which can reliably collect samples of the same surface area, In this case a cylindrical tube with serrations on one end, which has a fixed diameter. Next the sample is inserted into a sample holder which is connected to an electrical circuit. The sample holder is made of thin, conductive, heat resistant wire, shaped into an evaporation basket. Such as a nickel chromium alloy commercially known as NiChrome. The sample is enclosed within the reaction chamber by means of a lid, to retain the thermal breakdown products of the sample. The sample is then heated within the basket by electrical resistive heating, the sample will become completely broken down with heat above 1,755 degrees Fahrenheit; lead carbonate and lead chromate will be completely destroyed and converted to lead oxide at this temperature. Additionally vaporizing the sample allows the lead to become completely liberated from the paint matrix, very small particles of lead oxide mixed with un-oxidized carbon and other compounds in a relatively homogeneous fashion coat the interior of the reaction vessel. This allows for the lead to be easily dissolved in the next step regardless of its original form, chromate or carbonate. In order to react the lead oxide with common reagents like sodium rhodizoate or sodium sulfide the lead oxide must be dissolved into an aqueous medium, this is accomplished by washing the interior of the reaction vessel with an acidic liquid, hydrochloric acid is preferred for both its relatively safety and effectiveness in dissolving lead oxide. It is added via hypodermic instrument through the silicone cap. Next an addition of a chemical reagent, ammonium sulfide dissolved in water is preferred. Ammonium sulfide, when combined with lead, will yield the insoluble and black to grey colored lead sulfide. The amount of ammonium sulfide required is stoichiometrically matched to the level of lead that is below the regulated limit. Therefore if the quantity of lead exceeds the quantity of sulfide there will be remaining dissolved lead in the solution, this is the regulated quantity of lead. However if lower than regulated or zero levels of lead are present in the sample there will be no dissolved lead after the addition of sodium sulfide. In order to determine if there is excess lead in solution the solution will be reacted with a second reagent, here sodium rhodizonate is preferred, this can be accomplished by withdrawing an aliquot of the sample, again via hypodermic instrument and dispensing it into a substrate which is impregnated with sodium rhodizonate, here a cotton swab with sodium rhidizonate is preferred. Excess lead in the solution will react with the sodium rhodizonate and turn it purple to red, while a negative result will merely turn a yellow color. Since lead binds more tightly to sulfide than rhodizonate, the previously precipitated lead is sequestered in an insoluble and nonreactive form, allowing for quantitative determinations of lead levels.

In a first example the paint sample is circular, is one square centimeter in diameter and is extracted from the wall with a hollow metal tube with serrations on the test sampling side of the tube to remove a precise amount of paint from the wall. Once removed the sample is placed into the sample holder and after vaporization at at least 1755 Fahrenheit. The lead is digested with 5 ml of aqueous hydrochloric for a period of 5 minutes. Then 296 micrograms of ammonium sulfide is added to the resulting solution of lead HCl and shook for an additional minute, allowing all the sulfide ions to bind to lead ions if they are present. Next an aliquot of the liquid is withdrawn and deposited onto an absorbent cotton swab containing sodium rhodizonate, if there is excess lead present in solution the filter will turn red or violet depending on the concentration, indicating the presence of regulated amounts of lead in the paint. The device to complete the thermal breakdown of the sample component of the method comprises a battery power source fitted inside of a electronic controller with a 510 style female fitting on top, similar to a commonly found “box mod vape”. The reaction vessel is an open topped glass vessel with a female 510 style fitting on the bottom. The sample holder is suspended inside of the glass vessel by the circuit leads which are fused in place as the bottom of the glass vessel is melted and crimped during production and the leads attached to a male 510 fitting at the bottom of the reaction vessel. The production method is the same as with halogen capsule light bulbs in that the filament is fused into the closed bottom of the capsule, while the top is left open to allow for the addition of the sample to the reaction vessel. The cap for the reaction vessel is a silicone cover which has a top and sides, with the sides being a 5% smaller diameter than the opening of the reaction vessel allowing it to grip around the glass top allowing it to seal the contents of the vessel inside after being stretched over the top. Silicone has a self healing property to allow for the addition and withdrawal of liquid to and from the reaction chamber without opening it again, protecting the operator from exposure to the sample. The sample holder material is a high temperature resistance wire, an alloy of nickel and chromium is preferred. The basket is coiled in a basket shape to hold the sample and connected to the 510 fitting via the same method a filament within a halogen bulb is, using larger diameter, heat resistive and rigid lead in wires.

A second example uses the same method with the exception of the method of testing with sodium rhodizonate, in this example sodium rhodizonate which has been treated in a ball mill is suspended in isopropanol. This sodium rhodizonate slurry may be added to the reaction vessel after the ammonium sulfide reaction and observed for a color change.

A third example may dispense with dissolving of the lead oxide in an acidic aqueous medium and opt for its spontaneous conversion to a fluorescent form by the addition of methylammonium bromide to the sample holder, into the reaction vessel or onto a hygroscopic substrate placed within the reaction vessel prior to heating the sample to its point of decomposition. When the sample is heated the methylammonium bromide is deposited throughout the chamber and the lead oxide reacts with It creating a fluorescent reaction product. However this analysis, while sensitive is not as robust as sodium rhodizonate, since the fluorescent byproduct is only present in dry conditions, the chamber would need to be modified to reach quantitive levels of analysis. This can be accomplished by means of filtering the vapors of the paint sample through a hydroscopic medium absorbing some lead in said medium and allowing for only regulated lead to exit the medium and be deposited on a visible interior surface of the reaction vessel. By using activated charcoal felt to absorb both lead and moisture, then measuring the fluorescence on the terminal end of the activated carbon filter, model used ACF 1600 manufactured by CeraMaterial.

In a fourth embodiment the device contains reservoirs with reagents within its structure in such a manor that they may be transferred into the reaction vessel as controlled by the operator, either manually or in an automatic sequence using electronically controlled pumps.

In a fifth example after the sample is vaporized it is dissolved in acid, then the liquid is extracted into an organic layer, sulfydryl functionalized mesoporous alumina film, or another method of sequestering the lead, removing an aliquot of the leaded liquid or substrate and subsequently reacting the lead bearing material outside the vessel with methylammonium bromide to facilitate its conversion to the fluorescent crystalline methylammonium lead bromide.

In a sixth example there is a modified reaction chamber comprising a glass tube which is fitted over the 510 connector base, which has rubber o rings that form a seal with the glass cover. The bottom of the 510 connector contains an insulated pin which functions as the negative terminal of the circuit and after heating of the sample this insulated pin may be removed, allowing the operator to insert a needle to fill the reaction vessel with reagents through a silicone port that comprises the bottom of the vessel. This is manufactured in the same way as similar devices today which are used as soldering iron tips, however the addition of port which is plugged by silicone must be achieved by altering the components prior to assembly, and can be accomplished drilling each piece and injecting silicone into the port hole.

In a seventh example the sample is taken from soil, heated in the normal way then subjected to the normal course of reactions, however the ammonium sulfide is titrated to an amount related to the loading concentration of concern for soil. This method may also be utilized when an acid only digestion occurs, giving information on bioavailable lead.

In an eighth example the process follows the normal schema and instead of chemicals being used being used to analyze an aliquot of the sample the sample is analyzed by anodic stripping voltammetry.

In a ninth example the process follows the normal schema and precipitation occurs with an addition of ammonium sulfide before being analyzed by anodic stripping voltammetry. To aid in the regulation of results, preventing false positives and lowering the sensitivity needed for the voltammeter.

It should also be noted that samples beyond paint can be tested using this method, this is not meant to be an exhaustive declaration of the limitations of this method of analysis, or the format of possible variations of devices used to complete the analysis but merely to point out the glaring and longstanding issues with the prior art in solving this problem in paint. For example this method could be used to test for lead in food or blood by employing a more sensitive reagent like methylammonium bromide along with the aforementioned moisture scrubbers.

### BRIEF DESCRIPTION OF THE SEVERAL VIEWS OF THE DRAWING

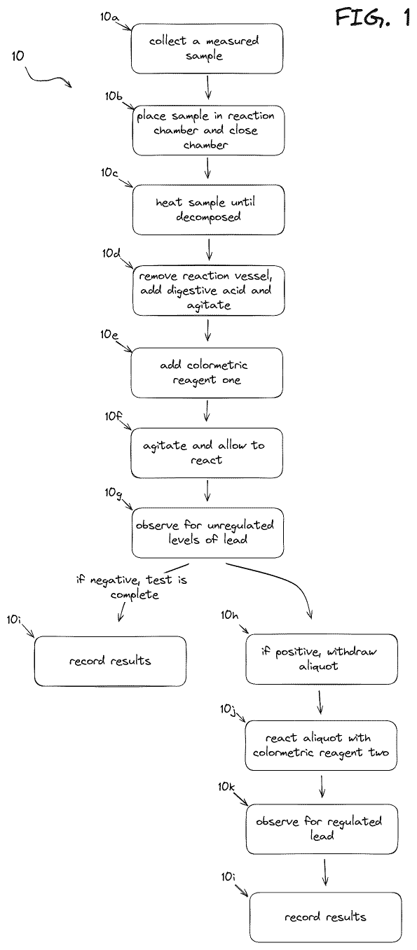

Referring to FIG. 1, a flow chart depicting the method of analysis is shown. Comprising the steps of 10a Collecting a measured sample, 10b Placing the sample in the reaction vessel and closing the chamber, 10c Heating the sample using the electronic controller until it is decomposed, 10d Removing the reaction vessel from the electronic controller, adding a digesting acid and agitating, 10e Adding colormetric agent one, 10f agitating and allowing the colormetric agent to react, 10g observing for unregulated levels of lead and; 10i recording the results if a negative result is found or 10h If a positive result is found withdrawing an aliquot of the sample, 10j reacting the aliquot colormetric reagent two, and 10i Recording the results.

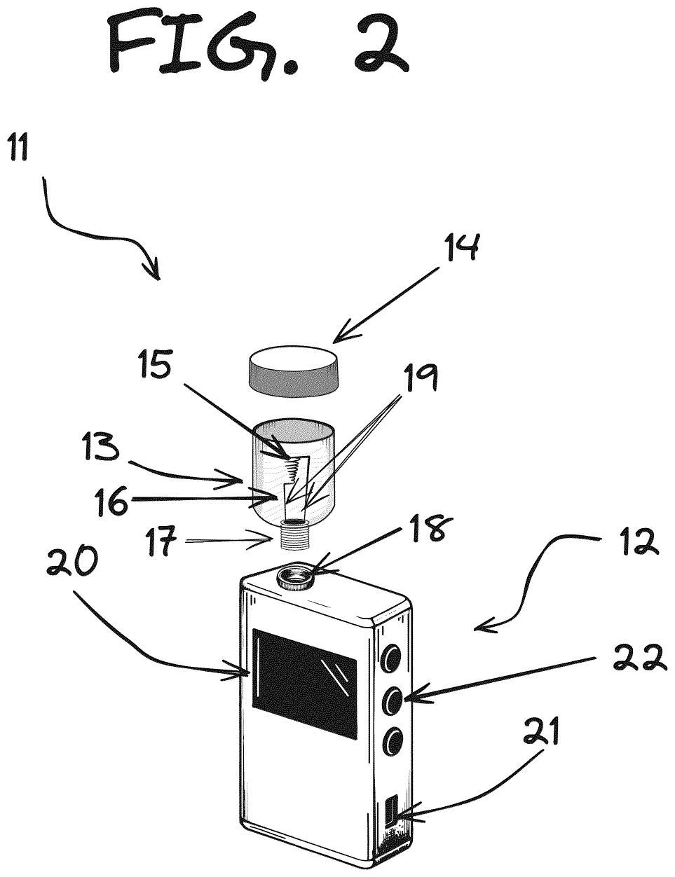

Referring to the drawing FIG. 2, a side view of the device 11 is shown. The device comprises an electricity distribution module with an rechargeable battery power supply, charging port supplying charge to the battery is shown as 21. Ideally this device is capable of delivering up to 60 watts of power for a period of 30 seconds. The device comprises an internal battery, microcontroller and information displayed on an instrumentation screen 20 the settings of the device are controllable by the operator via control panel 22, which is capable of distributing power to attached socket 18 which is ideally a female 510 connection, which delivers power through reaction vessel 13. The reaction vessel comprises circuit 16 which is made up of plug 17 which is a threaded male 510 connector, lead in support wires 19, ideally composed of nickel 18 gauge wire, a sample holder 15 which is ideally made of a temperature resistant alloy wire, NiCr with a diameter of 0.35 mm. Ideally comprising a coiled evaporation basket style filament with 9 winds, enabling it to hold and vaporize the sample. The reaction vessel is naturally open on the top but may be closed by means of reaction vessel cap 14 which is ideally composed of silicone.

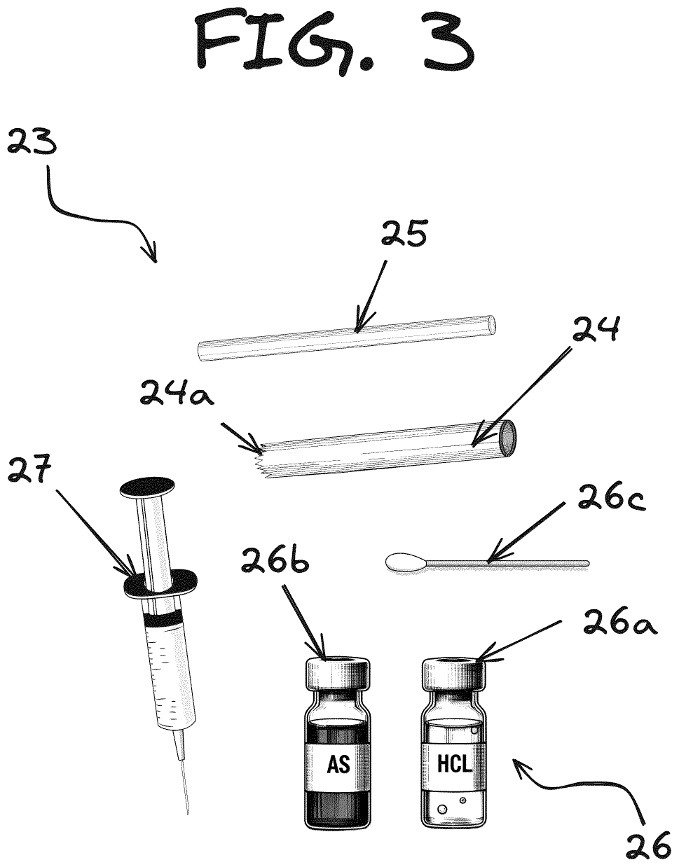

Referring to FIG. 3, a sample extraction tube 24 ideally comprised of steel, with an internal diameter of 10 mm and serrations on end 24a, sample releasing rod 25, ideally composed of High-Density Polyethylene and is both smaller in diameter and longer than the sample extraction tube by 20%, as well as chemical reagents 26, ideally comprising aqueous hydrochloric acid 26a ideally 0.1 mole hydrochloric acid in an aqueous solution, ammonium sulfide 26b ideally comprising aqueous ammonium sulfide at a concentration of 888 micrograms per milliliter and sodium rhodizonate impregnated onto an absorbent medium, in this case a cotton swab 26c. Additionally a painted surface, 28; a measured sample taken from that painted surface 29, a visual flow chart 30 and a negative and positive result for regulated lead 31, 32, respectively, are depicted.

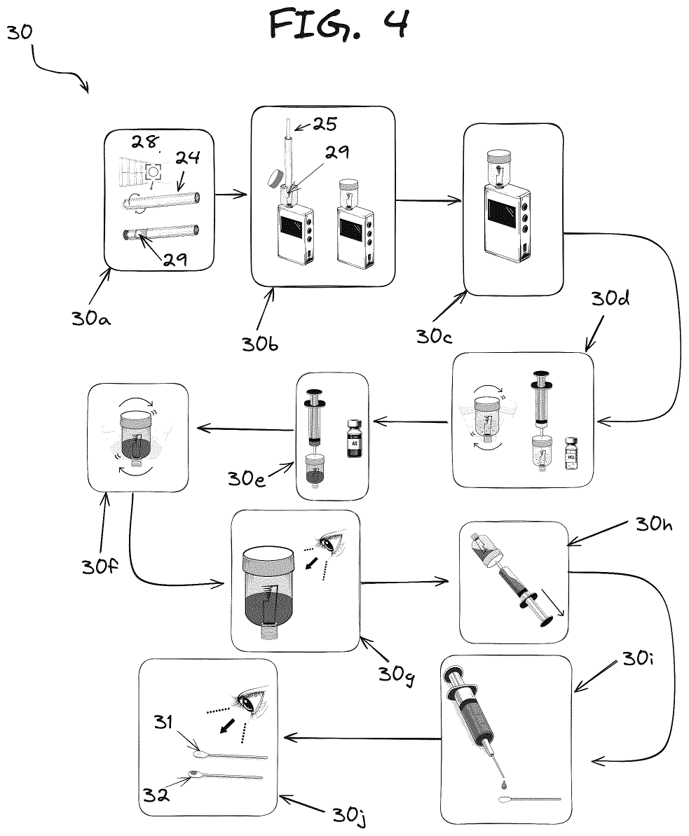

Referring to FIG. 4, a visual step by step depiction of the device carrying out the method is provided seen in 30 with summaries of the components of the invention marked by 11 and 23 and further descriptions of aspects of the testing environment, tools and methods depicted showing a painted surface 28, a measured sample taken from said surface 29, and results of the test depicted as cotton swabs 30 and 31. Additionally a step by step breakdown of the process is described starting with 32 selecting and removing a measured sample, 33 depositing the measured sample within the reaction vessel, 34 thermally decomposing the sample within the reaction chamber, 35 adding hydrochloric acid to dissolve the lead and agitating, 36 reacting the sample with ammonium sulfide (colormetric reagent one), 37 agitating the sample and allowing it to react, 38 observing the sample for a reaction, 39 withdrawing an aliquot of the sample, 40 depositing the sample onto a sodium rhodizonate impregnated absorbent material, in this case a cotton swab, 41 observing the swab for a color change to determine the presence of regulated lead, 31 indicating a negative result (orange) and 31 indicating a positive result (red-purple).

### A MARSHALING OF REFERENCE NUMERALS UTILIZED IN THE DRAWINGS

10—flowchart describing the method
10a—collect a measured sample
10b—place sample into reaction chamber
10c—heat sample until decomposed
10d—remove reaction vessel from socket add digestive acid and agitate
10e—add colormetric reagent one
10f—agitate and allow to react
10g—observe for unregulated levels of lead
10h if positive withdraw aliquot
10i—record results
10j—react aliquot with colormetric reagent 2
10k—observe for regulated lead
11—device for quantitative analysis of lead
12—electronic power controller
13—reaction vessel
14—reaction vessel cap
15—sample holder
16—reaction vessel power circuit
17—reaction vessel plug
18—socket
19—lead in support wires
20—instrumentation screen
21—battery recharge port
22—control panel
23—sample collection tools and reagents
24—sample extracting tube
24a—serrations on the tip of the extraction tube
25—sample releasing rod
26—chemical reagents
26a—vial of hydrochloric acid
26b—vial ammonium sulfide
26c—cotton swab impregnated with sodium rhodizonate
27—hypodermic instrument
28—a painted surface
29—a measured sample
30—visual flow chart
30a—depiction of a sample being taken
30b—depiction of sample being deposited and sealed into reaction chamber
30c—depiction of sample after thermal decomposition inside of the reaction chamber
30d—depiction of the addition of hydrochloric acid to the reaction chamber via hypodermic instrument and subsequent agitation
30e—depiction of the addition of ammonium sulfide to the reaction chamber
30f—depiction of agitation of the sample in the reaction chamber
30g—depiction of the observation of the sample in the reaction chamber for unregulated levels of lead
30h—depiction of the withdrawal of an aliquot of sample solution from the reaction chamber from a sample which tested positive for unregulated levels of lead
30i—depiction of the deposition of an aliquot of sample solution onto a rhodizonate doped cotton swab
30j—observation of the results of the test for regulated levels of lead in the sample
31—negative result for regulated lead
32—positive result for regulated lead

### DETAILED DESCRIPTION OF THE INVENTION

### A Detailed Description of the Inventive Method as Carried Out Using the Device

The invention process 10 is carried out by device 11 by first connecting reaction vessel 13 to electronic power controller 12, by inserting reaction vessel plug 17 into socket 18. Then by placing a measured sample of paint removed from a surface suspected of containing lead using sample extraction tube 24, which removes a measured sample 29 from a painted surface 28 by means of a serrated tip 24a, comprising Step 10a. The sample is placed into sample holder 15 by pushing the sample out of the sample extraction tube using sample releasing rod 25. The operator then seals the sample within reaction vessel 13 by means of reaction vessel cap 14, compromising Step 10b. Next the operator then activates device 12 by means of control panel 22. Which initiates a flow of electricity from the rechargeable battery held within device 12 through socket 18, through the reaction vessel power circuit 16, which is made up of lead in support wires 19, which complete a circuit through sample holder 15 which is heated by electrical resistance. This process heats and vaporizes the lead in the sample 29, this comprises Step 10c. Once the sample is reduced to ash and reaction vessel 13 and cools, the operator adds removes the reaction vessel 13 by unscrewing it from socket 18 then adds aqueous hydrochloric acid 26a to the reaction vessel 13 by first using hypodermic instrument 27 to withdraw liquid from 26a then passing hypodermic instrument 27, through reaction vessel cap 14 and adding 5 ml of the hydrochloric acid 0.1 molar solution and agitating for five minutes, this comprises Step 10d. Testing for lead begins by adding the colormetric reagent one, ammonium sulfide 26b, added in the same manner as the hydrochloric acid. The ammonium sulfide is at a volume of 0.33 ml of which contains 296 micrograms of ammonium sulfide, this comprises Step 10e. The operator then agitates for 30 seconds and allows the mixture to react for an additional minute, this comprises Step 10f. The operator then observes the sample for a first color change to brown, grey or black, this would indicate the presence of unregulated lead, this comprises Step 10g. The operator records the results if the sample is negative the testing has concluded, this comprises Step 10i. If the resultant mixture darkens then an aliquot, 0.5 ml of the mixture is withdrawn, this comprises Step 10h. The operator then deposits this aliquot onto a filter impregnated with sodium rhodizonate 26c, using a fresh hypodermic instrument 27, Step 10j. The filter is ideally a dry cotton swab with 4 mg of sodium rhodizonate impregnated on the tip, these swabs are manufactured by Spirochaete Research Labs, LLC and are commercially available. The operator then observes for the presence of regulated lead by looking at the swab 26c and making a determination of the presence or absence of regulated levels of lead in the sample by looking for a color change to red 32, if the swab only turns orange 31 than the sample is negative for regulated lead, this comprises Step 10k. Finally the operator records the results, concluding this method for quantitative determination of lead, this comprises Step 10i.

### Detailed Description of the Preferred Embodiments of the Invention

A measured sample 29 is taken from a painted surface 28 with sample extracting tube 24, which ideally comprises coring device with an inner diameter of 1.128 cm, in the present embodiment the surface area of the sample taken is 1 cm and sample extracting tube 24 comprises a steel tube with serrations on the sampling end 24a. The sample 29 may be removed from extracting tube 24 by means of sample releasing rod 25, which ideally is comprised of HDPE plastic and has a diameter 20% less than sample extracting tube 24, and a length which Is 20% longer than sample extracting tube 24. The reaction vessel comprises a cylindrical glass container known as reaction vessel 13 with an open top which has an interior diameter of 5 cm, and an interior height of 11 cm and closed bottom with a circuit beginning and terminating it in a male 510 style power connection 17, the circuit 16 and the bottom portion of the reaction vessel is manufactured in same configuration as in a commercially available halogen light bulb, using a cylindrically shaped die the fused glass at the bottom of the reaction vessel seals and holds the circuit and sample holder element in place, over which power plug 17 is fitted. The sample holder 15 is made of 0.3 mm nichrome alloy, 20% nickel 80% chromium, and comprises a coiled evaporation basket with 9 turns, and a height of 1.5 cm, the baskets diameter at the top is 1.5 cm and the bottom of the basket is closer the positive side off the circuit 16 compared to the top of the basket. The resistance material is connected to the lead in support wires 19 of the circuit 16 by welding. The circuits lead in wires 19 extends through the fused glass bottom of the tube and terminate in a male threaded 510 style connection 17 which corresponds to the female 510 style socket 18 found on the top of the electronic power controller 12. Once the sample 29 is placed in the sample holder 15, the reaction vessel cap 14, made of silicone is fitted over the top the reaction vessel 13, the reaction vessel cap 14 is stretched over the opening and prevents gas exchange from the interior of the reaction vessel 13 to the outside while permitting the delivery of reagents 26a, 26b into the vessel. Once the vessel cap 14 is affixed to the reaction vessel 13 the heating cycle is commenced. The sample holder 15 is energized by means of the electronic power controller 12 and the power circuit 16 and deliver thermal power to the sample 29 via electrical resistance in the sample holder 15. In the present embodiment the power cycle lasts 30 seconds using 55 watts of power for the duration, this allows sample to be heated above a temperature of 1755 degrees Fahrenheit. Once the heating cycle is completed the reaction vessel 13 is allowed to cool to the touch. Once cooled the reaction vessel is removed from the power supply and an addition of 5 ml of aqueous 0.1 molar hydrochloric acid 26a is added via hypodermic instrument 27 through the reaction vessel cap 14 and agitated. After a period of 5 minutes 296 micrograms of ammonium sulfide 26b in water is added via hypodermic instrument 27 and the reaction vessel 13 is again agitated for a period of 1 minute. Then the mixture is observed for the characteristic presentation of lead sulfide which is black to brown, if the results of this initial test for the presence of lead is negative the solution will not present as brown or black and no further testing is required, the results are recorded and the test is finished. If the initial test for unregulated lead is positive 0.5 ml of the sample mixture is withdrawn via hypodermic instrument 27 and deposited onto a cotton swab 26c containing 4 milligrams of sodium rhodizonate. If the solution contains remaining dissolved lead ions there will be a color change in the swab to red violet or pink, constant with the color of lead rhodizonate. Finally the operator records the color of the cotton swab and makes a determination of the presence or absence of regulated lead.

What is claimed is:

1. A method for the quantitative detection of lead in a sample, wherein said method comprises
selecting a sample of known mass or surface area
exposing the sample with heat sufficient to vaporize lead chromate
capturing the vaporized byproducts within a reaction vessel
washing the reaction vessel with aqueous acid to yield lead in solution
adding a titrate amount of a first reagent capable of reacting with lead to form an insoluble precipitate
recording the results
reacting the sample with a second reagent which is capable of reacting with dissolved lead to form a colored complex
Recording the results.

2. The method of claim one where the sample heated to at least 1755 degrees Fahrenheit.

3. The method of claim one wherein the acid use to wash the reaction vessel is hydrochloric acid.

4. The method of claim one where the first reagent is a chemical capable of creating a colored reaction product.

5. The method of claim one where the first chemical has a stronger binding affinity to lead than the second.

6. The method of claim one where the first chemical is aqueous ammonium sulfide and the second is sodium rhodizonate.

7. The method of claim one where the sample comprises a paint chip with a surface area of 1 square centimeter and the amount of the first reagent capable of reacting with lead to form a color change is sufficient to react with 900 micrograms of lead.

8. The method of claim one where the sample comprises a paint chip with a surface area of 1 square centimeter and the amount of the first reagent capable of reacting with lead to form a color change is sufficient to react with 450 micrograms of lead.

9. A device to carry out the method of claim one comprising
A reaction vessel with integrated sample holder comprising a circuit capable of intermittent connection to a power source
An electronic power source capable to delivering power to the sample holder
A sample collector comprising a hollow tube with serrations on one end.

10. The device of claim 9 wherein the reaction vessel is capable of being sealed by a removable silicone cap.

11. The device of claim 9 wherein the sample holder capable of reaching temperatures above 1755f when powered by said electronic power source.

12. The device of claim 9 wherein the sample holder is a 30 gauge wire formed into a basket capable of holding a paint chip.

13. The device of claim 9 wherein the reaction vessel is a vessel with a sealed bottom and open top.

14. The device of claim 10 wherein the reaction vessel cap is a form of silicone capable of acting as port for the addition and removal of liquids via hypodermic instrument and prevents the contents of the reaction vessel from escaping otherwise.

15. The method of claim 1 wherein the sample is ultimately analyzed by spectroscopic methods.

16. The device of claim 10 wherein the electronic device controls the power output by microprocessor.

17. The device of claim 10 wherein the device contains reservoirs of reagents which can be added in sequence in pre metered amounts by the operator.

18. The method of claim 1 wherein the final step comprises the deposition of a portion of the sample mixture into an absorbent impregnated with sodium rhodizonate.

19. The device of claim 10 wherein the device comprises a kit which includes the reagents, aqueous hydrochloric acid, aqueous ammonium sulfide and sodium rhodizonate, a sample extraction tube, a sealable reaction vessel and a electronic power controller.
